(19) United States
(12) Patent Application Publication
(10) Pub. No.: US 2025/0157045 A1
(43) Pub. Date: May 15, 2025

(54) INDIVIDUAL-TREE SEGMENTATION METHOD OF UAV LIDAR POINT CLOUD BASED ON CANOPY MORPHOLOGY

(71) Applicants: University Of Electronic Science And Technology Of China, Chengdu (CN); Yangtze Delta Region Institute (Huzhou), University Of Electronic Science And Technology Of China, Huzhou (CN)

(72) Inventors: Shihua Li, Chengdu (CN); Shunda Zhao, Chengdu (CN); Yuyang Guo, Chengdu (CN); Fugui Luo, Huzhou (CN); Minfeng Xing, Huzhou (CN)

(21) Appl. No.: 18/518,513

(22) Filed: Nov. 23, 2023

(30) Foreign Application Priority Data
Nov. 9, 2023 (CN) 202311487560X

(51) Int. Cl. G06T 7/187; G06T 7/11; G06T 7/155; G06T 7/521

(52) U.S. Cl. CPC G06T 7/187; G06T 7/11; G06T 7/155; G06T 7/521; G06T 2207/10028; G06T 2207/10032; G06T 2207/20036; G06T 2207/20156; G06T 2207/30188

(57) ABSTRACT

Provided is an individual-tree segmentation method of UAV LiDAR point cloud based on canopy morphology. The method uses woodland data obtained by a UAV LiDAR to: extract initial canopies from a CHM based on a region growing algorithm, determine whether each initial canopy is a correct segmentation canopy according to the number of local density maximum points in each initial canopy, finely segment each wrong segmentation canopy according to canopy morphology to obtain an updated set of tree tops, and finally use each of the updated set of tree tops as a seed point for performing the region growing algorithm to thereby obtain a final individual-tree segmentation result. The method make full use of height information and density information contained in a tree point cloud; and under the guidance of the density information, a wrong segmentation tree can be more accurately identified.

### TECHNICAL FIELD

The disclosure relates to the technical field of unmanned aerial vehicle (UAV) Light Detection and Ranging (LiDAR) point cloud data processing, particularly to an individual-tree segmentation method of UAV LiDAR point cloud based on canopy morphology.

### BACKGROUND

Forest is an important terrestrial ecosystem, and tree information of the forest plays an important role in the investigation of forest resources and the formulation of forest management strategies. The investigation of individual-tree parameters is the basis of fine investigation of forest resources, so the accurate segmentation of individual-tree is the premise of investigation of forestry parameters. Since the traditional forestry investigation is laborious and difficult to meet the requirements of investigation of a large-scale forest, a remote sensing technology has become the most commonly used method for the investigation of the large-scale forest. An airborne LiDAR can quickly obtain high-precision three-dimensional (3D) point cloud information of the large-scale forest, and compared with traditional remote sensing methods, an active remote sensing technology used by a LiDAR can penetrate canopies to obtain internal structure information of the forest. However, the high equipment and operating costs of the airborne LiDAR limit its application in the investigation of forest resources. In recent years, a UAV LiDAR has been widely used in in the investigation of forest resources due to its advantages of low cost, convenient operation and high flexibility.

Individual-tree segmentation methods based on UAV LiDAR point cloud data can be mainly divided into a grid-based method and a point-based method. The grid-based method usually uses a Gaussian filter to smooth the canopy height model (CHM), then uses a local maximum filter to search the local maximum height values as the tree tops, and then uses the tree tops as the seed points for regional growing or watershed segmentation. The grid-based method has high computational efficiency, but its accuracy depends largely on the setting of the size of the filter window, and there is information loss in the process of generating the CHM by interpolation. Further, the point-based method uses clustering algorithms such as region growing algorithm, k-means algorithm, and mean-shift algorithm to complete segmentation according to the three-dimensional spatial distribution and vertical structure characteristics of the point cloud. The point-based method avoids the loss of information in the process of generating the CHM by point cloud interpolation, and has high accuracy; however, an application thereof is limited due to the huge calculation and time consumption.

At present, some scholars have proposed an individual-tree segmentation method combing grids and points. The idea of this method is to get initial segmentation trees by the grid-based method, and then refine the wrong segmentation trees according to point cloud distribution of different trees. However, at present, there is no method that can accurately and effectively identify the wrong segmentation trees and segment them finely.

### SUMMARY

The disclosure is proposed to solve the above problems existing in the related art. Therefore, an individual-tree segmentation method of UAV LiDAR point cloud based on canopy morphology is needed, and the method is specifically a canopy morphology segmentation method based on a grid-based region growing algorithm and density-based information guidance.

An embodiment of the disclosure provides an individual-tree segmentation method of UAV LiDAR point cloud based on canopy morphology, which includes:
acquiring UAV LiDAR point cloud data, and preprocessing the UAV LiDAR point cloud data to obtain a canopy height model (CHM) and a point cloud density model (PDM);
extracting canopies and obtaining a set of tree tops according to the CHM and the PDM;
determining each correct segmentation canopy and each wrong segmentation canopy of the canopies according to the number of local density maximum points in each of the canopies; and
performing fine segmentation on each wrong segmentation canopy according to canopy morphology to update the set of tree tops and thereby obtain an updated set of treetops, taking each tree top of the updated set of tree tops as a seed point, and performing region growing on each tree top to thereby obtain a final individual-tree segmentation result.

In an embodiment, the preprocessing the UAV LiDAR point cloud data to obtain a CHM and a PDM includes:
performing ground filtering on the UAV LiDAR point cloud data to extract ground points and non-ground points from the UAV LiDAR point cloud data; and
performing an interpolating process on the ground points to obtain a digital elevation model (DEM), and normalizing the non-ground points using the DEM to obtain normalized non-ground points; and

performing an interpolating process on the normalized non-ground points to obtain the CHM; and for each grid unit Gi of the CHM, recording the number of projection points falling in the grid unit Gi as a new value of the grid unit Gi, to thereby generate the PDM.

In an embodiment, the extracting canopies and obtaining a set of tree tops according to the CHM and the PDM includes:
smoothing each of the CHM and the PDM to thereby obtain a smoothed CHM and a smoothed PDM, determining local maximum points of the smoothed CHM and local maximum points of the smoothed PDM, taking the local maximum points of the CHM as tree tops H, and taking the local maximum points of the PDM as local maximum density points D of point cloud;
taking each of the tree tops H as a seed point to perform region growing on the CHM, and assigning each adjacent grid point of the seed point satisfying a set condition to a canopy Cᵢ to which the seed point belongs; and
taking the canopy Cᵢ as an independent area, where the canopy Cᵢ has only one maximum height as a tree top of the canopy Cᵢ.

In an embodiment, the setting condition for assigning the adjacent grid point to the canopy Cᵢ to which the seed point belongs includes:
1) a height of the adjacent grid point is higher than 60% of a height of the seed point;
2) a height of the adjacent grid point is higher than 60% of an average height of the canopy Cᵢ; and
3) a maximum canopy width of the canopy Cᵢ does not exceed 10 meters.

In an embodiment, the wrong segmentation canopy includes an over-segmentation canopy and an under-segmentation canopy; and the determining each correct segmentation canopy and each wrong segmentation canopy of the canopies according to the number of local density maximum points in each of the canopies, includes:
in a situation that there is only one local maximum density point D in a canopy Cᵢ, determining the canopy Cᵢ as the correct segmentation canopy;
in a situation that there is no local maximum density point D in the canopy Cᵢ, determining the canopy Cᵢ as the over-segmentation canopy;
in a situation that there are two or more local maximum density points D in the canopy Cᵢ, determining the canopy Cᵢ as the under-segmentation canopy; and
recording a tree top H and a local maximum density point D of each wrong segmentation canopy.

In an embodiment, the performing fine segmentation on each wrong segmentation canopy according to canopy morphology to update the set of tree tops and thereby obtain an updated set of tree tops, taking each tree top of the updated set of tree tops as a seed point, and performing region growing on each tree top to thereby obtain a final individual-tree segmentation result, includes:
projecting all points of each over-segmentation canopy onto an xoy plane to obtain a point set P={p₁, p₂, p₃, . . . , pₙ}, and calculating a covariance matrix cov according to the following formula:

$$cov = \frac{1}{n - 1} ( P - \overline{p} ) {( P - \overline{p} )}^{T} ,$$

where p̅ represents an average value in dimensions of the point set P, n represents the number of the all points of the over-segmentation canopy OCᵢ, and T represents a matrix transposition operation;
performing singular value decomposition on the covariance matrix cov to thereby obtain two eigenvalues λ₁ and λ₂ and two eigenvectors α₁ and α₂, where λ₁ corresponds to a major axis of an ellipse and λ2 corresponds to a minor axis of the ellipse; and in a situation of λ₁/λ₂>3, determining the over-segmentation canopy OCᵢ as an over-segmentation canopy, assigning the over-segmentation canopy OCᵢ to a nearest correct segmentation canopy to the over-segmentation canopy OCᵢ, and removing a tree top Hᵢ corresponding to the over-segmentation canopy OCᵢ from a set of tree tops, otherwise, determining the over-segmentation canopy OCᵢ as a correct segmentation canopy;
taking a tree top H of each under-segmentation canopy UCᵢ as a reference point to obtain a vertical plane containing the tree top H and a local maximum density point Dᵢ and perpendicular to the xoy plane, and projecting a point cloud within a neighborhood of 0.2 meters of the vertical plane onto the vertical plane to obtain a vertical sectional view;
extracting canopy surface points in the vertical sectional view, and performing polynomial fitting on the canopy surface points to obtain a canopy surface morphology fitting function; determining that the local maximum density point Dᵢ is a top of a under-segmentation tree in a situation that there is a minimum value between the tree top H and the local maximum density point Dᵢ of the canopy surface morphology fitting function, and adding the local maximum density point Dᵢ to the set of tree tops for updating the set of tree tops; and determining that the local maximum density point Dᵢ is not a tree top in a situation that there is no minimum value between the tree top H and the local maximum density point Dᵢ of the canopy surface morphology fitting function;
after all wrong segmentation canopies are segmented, obtaining the updated set of tree tops; and
taking each tree top of the updated set of tree tops as a seed point for performing region growing to thereby obtain the final individual-tree segmentation result.

In an embodiment, the taking each tree top of the updated set of tree tops as a seed point, and performing region growing on each tree top to thereby obtain a final individual-tree segmentation result, includes:
taking each tree top of the updated set of tree tops as a seed pixel;
comparing the seed pixel with each pixel in a surrounding neighborhood of the seed pixel; and
in a situation of the pixel satisfying the set condition, merging the seed pixel and the pixel to obtain a merged pixel, and taking the merged pixel as a new seed pixel to continue to grow outward until there is no pixel satisfying the set condition.

In an embodiment, the individual-tree segmentation method of UAV LiDAR point cloud based on canopy morphology further includes: applying the final individual-tree segmentation result on the mobile terminal in performing investigation of forest resources and formulation of forest management strategies.

In an embodiment, the individual-tree segmentation method of UAV LiDAR point cloud based on canopy morphology is implemented by an individual-tree segmentation device including a processor and a memory with an individual-tree segmentation application stored therein; the individual-tree segmentation application, when executed by the processor, is configured to implement the individual-tree segmentation method of UAV LiDAR point cloud based on canopy morphology and is further configured to send, over the Internet, the final individual-tree segmentation result to a mobile terminal of forest management personnel; and an application installed in the mobile terminal is configured to: receive the final individual-tree segmentation result, and display the final individual-tree segmentation result on the mobile terminal to assist the forest management personnel to performing investigation of forest resources and formulation of forest management strategies based on the final individual-tree segmentation result.

The disclosure has at least the following beneficial effects.

The disclosure can make full use of height information and density information contained in a tree point cloud; and under the guidance of the density information, a wrong segmentation tree can be more accurately identified, thereby addressing the problem of the low utilization rate of point cloud information in the traditional methods, and providing a novel idea for individual-tree segmentation.

### BRIEF DESCRIPTION OF DRAWINGS

In accompanying drawings, which are not necessarily drawn to scale, the same reference numerals may describe similar parts in different drawings. Similar reference numerals with letter suffixes or different letter suffixes may indicate different examples of similar parts. The accompanying drawings generally illustrate various embodiments by way of examples and are not intended to limit the various embodiments, and the accompanying drawings together with the specification and claims serve to explain the embodiments of the disclosure. Where appropriate, the same reference numerals throughout the accompanying drawings refer to the same or similar parts. The described embodiments below are exemplary and are not intended to be exhaustive or exclusive embodiments of methods of the disclosure.

FIG. 1 illustrates a schematic flowchart of an individual-tree segmentation method of UAV LiDAR point cloud based on canopy morphology according to an embodiment of the disclosure.

FIGS. 2A-2B illustrate schematic views of coarse segmentation results based on region growing according to an embodiment of the disclosure.

FIG. 3 illustrates a schematic view of a fine segmentation principle based on canopy morphology according to an embodiment of the disclosure.

FIGS. 4A-4D illustrate a schematic view of a final result of individual-tree segmentation according to an embodiment of the disclosure.

### DETAILED DESCRIPTION OF EMBODIMENTS

In order to make the skilled in the art better understand the technical solutions of the disclosure, the disclosure will be described in detail with the accompanying drawings and specific embodiments. The embodiments of the disclosure will be described in further detail below with reference to the accompanying drawings and specific examples, but they are not taken as limitations of the disclosure. If the steps described herein are not necessarily related to each other, the order in which the steps are described as examples herein should not be regarded as a limitation, and the skilled in the art should know that the steps can be adjusted in order, as long as the logic between the steps is not affected and thus the whole process cannot be realized.

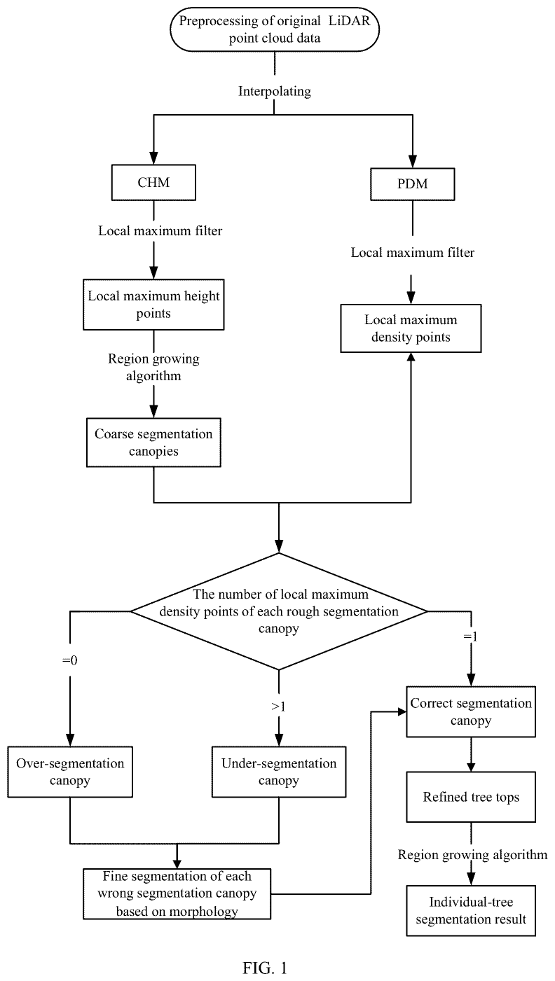

An embodiment of the disclosure provides an individual-tree segmentation method of UAV LiDAR point cloud based on canopy morphology, which is shown in FIG. 1, and includes the following steps 1-4.

In the step 1, UAV LiDAR point cloud data is acquired and preprocessed to obtain a canopy height model (CHM) and a point cloud density model (PDM).

The step 1 specifically realizes preprocessing of the UAV LiDAR point cloud data, and can be realized by the following steps 1-1 and 1-2.

In the step 1-1, ground filtering is performed on original UAV LiDAR point cloud data (i.e., the UAV LiDAR point cloud data) of an experimental area to extract ground points and non-ground points from an original point cloud (i.e., the original UAV LiDAR point cloud data), an interpolating process is performed on the ground points to generate a digital elevation model (DEM), and a normalizing process is performed on the non-ground points to obtain normalized non-ground points.

In the step 1-2, an interpolating process is performed on the normalized non-ground points to obtain the CHM; and for each grid unit Gi of the CHM, the number of projection points falling in the grid unit Gi is recorded as a new value of the grid unit Gi, to thereby generate the PDM.

It should be noted that a resolution of each of the CHM and the PDM can be set to 0.3 meters (m) to 0.5 m as required.

In the step 2, canopies are extracted and a set of tree tops is obtained based on the CHM and the PDM.

The step 2 is used realize a canopy coarse segmentation based on a region growing algorithm. A principle of the region growing algorithm is that: a tree top is first designated as a seed pixel; the seed pixel is compared with each pixel in a surrounding neighborhood of the seed pixel; ands if the pixel satisfies a condition (i.e., the set condition described below), the pixel and the seed pixel is merged to obtain a merged pixel, and the merged pixel is designated as a new seed point to continue to grow outward until there is no pixel that satisfies the condition.

Based on the above principle, the step 2 can be specifically realized by the following steps 2-1 to 2-3.

In the step 2-1, a smoothing processing is performed on each of the CHM and the PDM by using a Gaussian filter to thereby obtain a smoothed CHM and a smoothed PDM, then local maximum points of the smoothed CHM and local maximum points of the smoothed PDM are determined by using local maximum filters respectively, and the local maximum points of the CHM are taken as tree tops H. Since a value of each grid in the PDM represents a density of a point cloud, the local maximum points of the PDM are taken as local maximum density points D of the point cloud.

It should be noted that a standard deviation of normal distribution σ of the Gaussian filter can be set to 1, and a window size of each of the local maximum filters can be set to 5 pixels.

In the step 2-2, each of the tree tops H in the step 2-1 is taken as a seed point to perform the region growing algorithm on the CHM; each adjacent grid point of the seed point that satisfies the following set condition is assigned to a canopy Cᵢ to which the seed point belongs, to thereby obtain the canopies. The following set condition includes:
1) a height of the adjacent grid point is higher than 60% of a height of the seed point;
2) a height of the adjacent grid point is higher than 60% of an average height of the canopy Cᵢ; and
3) a maximum canopy width of the canopy Cᵢ does not exceed 10 m.

In the step 2-3, each independent region obtained by the region growing algorithm is the canopy Cᵢ (i.e., coarse segmentation canopy) obtained by coarse segmentation, and the canopy Cᵢ has only one maximum height point as a tree top of the canopy Cᵢ.

In the step 3, each correct segmentation canopy and each wrong segmentation canopy of the canopies are determined according to the number of local maximum density points in each of the canopies.

The step 3 specifically realizes the principle of classifying the wrong segmentation canopy based on local density information and discriminating the wrong segmentation canopy based on the local density information: trees in a forest can be regarded as having a multimodal distribution, and each canopy has a local maximum height point and a local maximum density point; for a tree with a regular shape, positions corresponding to the local maximum height point and the local density maximum point almost coincide. Therefore, whether the canopy is segmented correctly that can be determined according to the number of local maximum density points of each of the canopies.

Based on the above principle, the step 3 can be realized by the following steps 3-1 and 3-2.

In the step 3-1, the coarse segmentation canopy is classified according to the following set condition:
1) if there is only one local maximum density point D in the canopy Cᵢ, the canopy Cᵢ is determined as a correct segmentation canopy;
2) if there is no local maximum density point D in the canopy Cᵢ, the canopy Cᵢ is determined as an over-segmentation canopy OC; and
3) if there are two or more local maximum density points D in the canopy Cᵢ, the canopy Cᵢ is determined as an under-segmentation canopy UC.

In the step 3-2, a tree top H and a local maximum density point D of each wrong segmentation canopy are recorded.

In the step 4, each wrong segmentation canopy is finely segmented according to canopy morphology to update the set of tree tops and thereby obtain an updated set of tree tops, and each tree top of the updated set of treetops is taken as a seed point for performing the region growing algorithm to obtain a final individual-tree segmentation result.

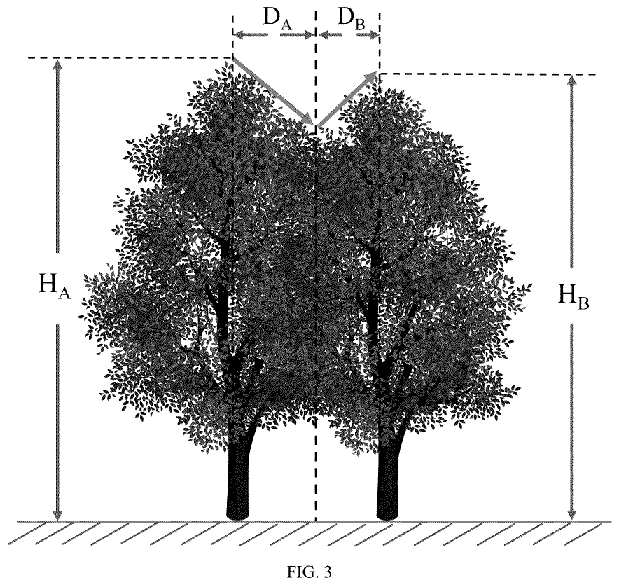

Specifically, the step 4 is used to realize fine segmentation based on canopy morphology. As shown in FIG. 3, a principle of the fine segmentation of wrong segmentation canopy based on canopy morphology is as follows: for two intersecting trees, a boundary (between distances D_{A} and D_{B}) between two canopies is a local minimum height, and a tree top of each of the two trees is a local maximum height (i.e., H_{A} and H_{B}); the height of a canopy surface shows a trend of first decreasing and then increasing from one tree top to another tree top; and therefore, the fine segmentation can be completed by finding a vertical cross-section between the two intersecting trees and determining a shape of a fitting function of the vertical cross-section.

Based on the above principle, the step 4 can be realized by the following steps 4-1 to 4-3:
step 4.1, projecting all points of each over-segmentation canopy OCᵢ onto an xoy plane to obtain a point set P={p₁, p₂, p₃, . . . , pₙ}, and calculating a covariance matrix cov according to the following formula:

$$cov = \frac{1}{n - 1} ( P - \overline{p} ) {( P - \overline{p} )}^{T} ,$$

where p̅ represents an average value in dimensions of the point set P, n represents the number of the all points of the over-segmentation canopy OCᵢ, and T represents a matrix transposition operation; and
performing singular value decomposition on the covariance matrix cov to thereby obtain two eigenvalues λ₁ and λ₂ (λ₁>λ₂) and two eigenvectors α₁ and α₂, where λ₁ corresponds to a major axis of an ellipse and λ2 corresponds to a minor axis of the ellipse; in a situation of λ₁/λ₂>3, determining the over-segmentation canopy OCᵢ as an over-segmentation canopy, assigning the over-segmentation canopy OCᵢ to a nearest correct segmentation canopy to the over-segmentation canopy OCᵢ, and removing a tree top Hᵢ corresponding to the over-segmentation canopy OCᵢ from a set of tree tops H_{f}, otherwise, determining the over-segmentation canopy OCᵢ as a correct segmentation canopy;
step 4-2, taking a tree top H of each under-segmentation canopy UCᵢ as a reference point to obtain a vertical plane containing the tree top H and a local maximum density point Dᵢ and perpendicular to the xoy plane, and projecting a point cloud within a neighborhood of 0.2 meters of the vertical plane is projected onto the vertical plane to obtain a vertical sectional view; and
extracting canopy surface points in the vertical sectional view, and performing polynomial fitting on the canopy surface points to obtain a canopy surface morphology fitting function; determining that the local maximum density point Dᵢ is a top of a under-segmentation tree in a situation that there is a minimum value between the tree top H (a point corresponding to the tree top H) and the local maximum density point Dᵢ ((a point corresponding to the local maximum density point Dᵢ) of the canopy surface morphology fitting function, and adding the local maximum density point Dᵢ to the set of tree tops H_{f}, and determining that the local maximum density point Dᵢ is not a top in a situation that there is no minimum value between the tree top H and the local maximum density point Dᵢ of the canopy surface morphology fitting function; and
step 4-3, repeating the step 4-1 and the step 4-2 until all wrong segmentation canopies are finely segmented to thus obtain a final set of tree tops H_{f} (i.e., the updated set of tree tops); taking each of the final set of tree tops H_{f} as a seed point to re-performing the region growing algorithm in the step 2-2 to obtain the final individual-tree segmentation result.

In the disclosure, an experiment is conducted in combination with specific sample data according to the method described above, and the feasibility and progress of the disclosure is verified.

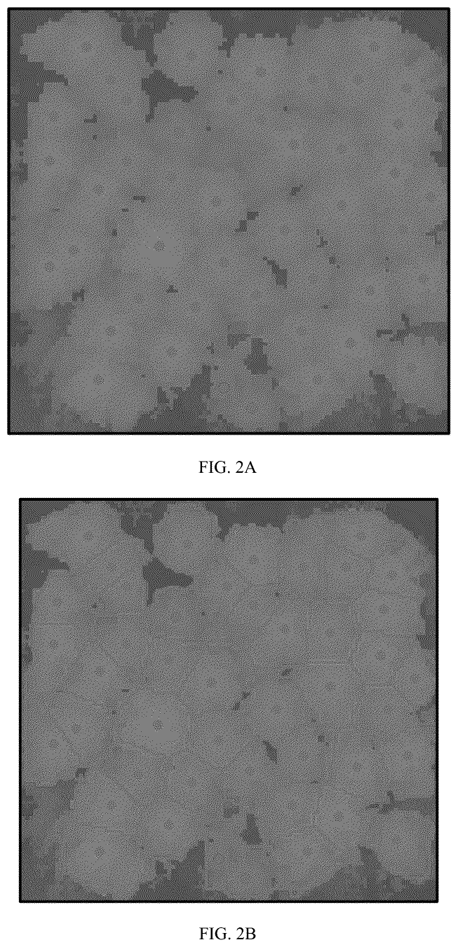

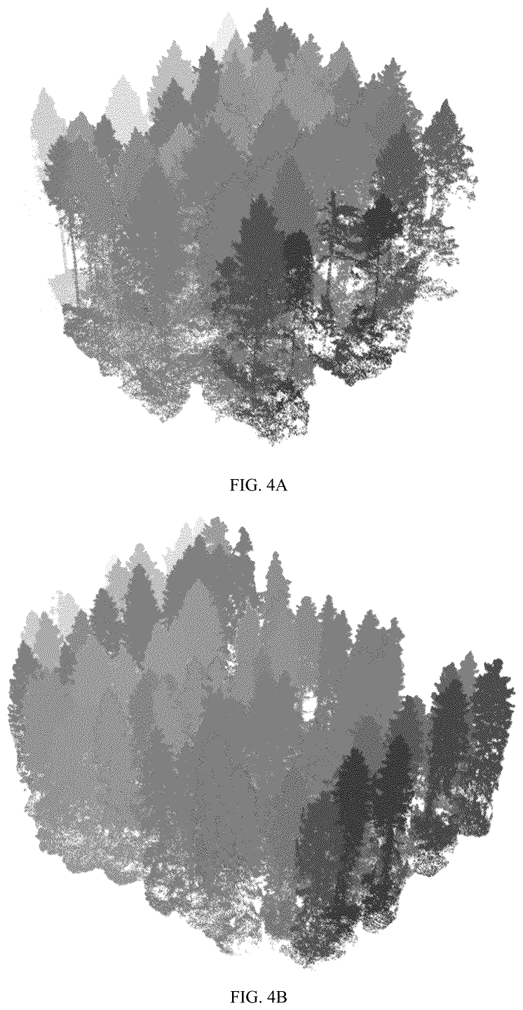

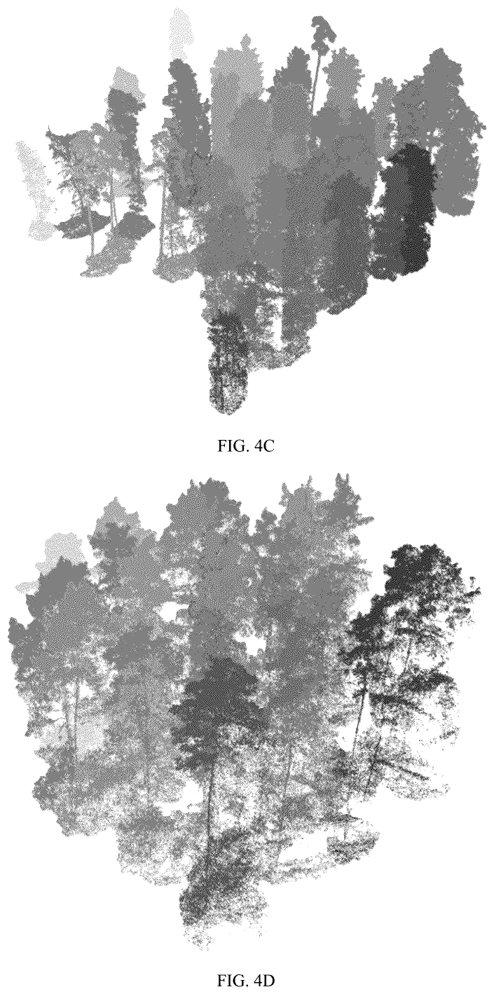

In the disclosure, data of four sample areas from a public data set of Bretten Forest (49 00′ 36″ N, 8 41′ 35″ E) in Germany are taken as target sample area data, and then the following steps 1-4 are performed:
step 1, using a cloth filtering algorithm to extract ground points and non-ground points from an original point cloud, performing a bilinear interpolation process on the ground points to obtain a DEM with a resolution of grid of 0.5 m, and performing a normalizing process on the non-ground points to obtain a CHM and a PDM with a resolution of 0.5 m;
step 2, smoothing each of the CHM and the PDM by using a Gaussian filter with a standard deviation of normal distribution σ of 1, and determining local maximum points of each of the CHM and the PDM by using local maximum filters each with a window size is 5×5, as shown in FIG. 2A;
step 3, taking each of the local maximum points of the CHM as a seed point for performing the region growing algorithm to obtain coarse segmentation canopies, as shown in FIG. 2B;
step 4, according to the number of local maximum points of the PDM contained in each coarse segmentation canopy, segmenting the coarse segmentation canopies into three categories: correct segmentation canopies, over-segmentation canopies, and under-segmentation canopies; and
step 5, according to canopy morphological characteristics, refining the over-segmentation canopies and the under-segmentation canopies to obtain a finely segmented set of tree tops, taking each of the finely segmented set of tree tops as a seed point for performing the region growing algorithm to obtain a final individual-tree segmentation result, as shown in FIGS. 4A-4D (respectively corresponding to the four sample areas).

Accuracy evaluation is performed, and specifically, five accuracy indexes for the coarse segmentation and the fine segmentation are calculated, and include an extraction rate (ER), a matching rate (MR), a commission error (CR), an omission error (OR), and a F score, as shown in Table 1.

TABLE 1
Accuracy evaluation parameters

| Sample | | | | | | |
|---|---|---|---|---|---|---|
| area | segment | ER | MR | CR | OR | F |
| 1 | coarse | 0.83 | 0.83 | 0 | 0.16 | 0.91 |
| | fine | 1 | 0.98 | 0.02 | 0.02 | 0.98 |
| 2 | coarse | 0.78 | 0.78 | 0 | 0.22 | 0.88 |
| | fine | 0.99 | 0.98 | 0.01 | 0.02 | 0.98 |
| 3 | coarse | 0.75 | 0.74 | 0.02 | 0.26 | 0.84 |
| | fine | 1 | 0.88 | 0.12 | 0.12 | 0.88 |
| 4 | coarse | 0.88 | 0.88 | 0 | 0.12 | 0.94 |
| | fine | 0.96 | 0.96 | 0 | 0.04 | 0.98 |

As can be seen from the above example, the disclosure utilizes three-dimensional laser point cloud data of forest trees obtained by a UAV laser radar, fully utilizes the height information and the density information in the point cloud, and combines the grid-based and point-based methods to complete the individual-tree segmentation of the sample area through the coarse segmentation based on the region growing algorithm and the fine segmentation based on the canopy morphology. The result shows that the method can overcome the shortcoming of low efficiency of the traditional method, and a corresponding accuracy of individual-tree segmentation is excellent.

The above is merely the exemplary embodiments of the disclosure, but the scope of protection of the disclosure is not limited thereto. Any technical solution obtained by equivalent substitution or change by any person familiar with the technical field according to the technical solutions and the inventive concept of the disclosure should be fall within the scope of protection of the disclosure.

What is claimed is:

1. An individual-tree segmentation method of unmanned aerial vehicle (UAV) Light Detection and Ranging (LiDAR) point cloud based on canopy morphology, comprising:
acquiring UAV LiDAR point cloud data, and preprocessing the UAV LiDAR point cloud data to obtain a canopy height model (CHM) and a point cloud density model (PDM);
extracting canopies and obtaining a set of tree tops according to the CHM and the PDM;
determining each correct segmentation canopy and each wrong segmentation canopy of the canopies according to the number of local density maximum points in each of the canopies; and
performing fine segmentation on each wrong segmentation canopy according to canopy morphology to update the set of tree tops and thereby obtain an updated set of tree tops, taking each tree top of the updated set of tree tops as a seed point, and performing region growing on each tree top to thereby obtain a final individual-tree segmentation result.

2. The individual-tree segmentation method of UAV LiDAR point cloud based on canopy morphology as claimed in claim 1, wherein the preprocessing the UAV LiDAR point cloud data to obtain a CHM and a PDM, comprises:
performing ground filtering on the UAV LiDAR point cloud data to extract ground points and non-ground points from the UAV LiDAR point cloud data;
performing an interpolating process on the ground points to obtain a digital elevation model (DEM), and normalizing the non-ground points using the DEM to obtain normalized non-ground points; and
performing an interpolating process on the normalized non-ground points to obtain the CHM; and for each grid unit of the CHM, recording the number of projection points falling in the grid unit as a new value of the grid unit, to thereby generate the PDM.

3. The individual-tree segmentation method of UAV LiDAR point cloud based on canopy morphology as claimed in claim 1, wherein the extracting canopies and obtaining a set of tree tops according to the CHM and the PDM, comprises:
smoothing each of the CHM and the PDM to thereby obtain a smoothed CHM and a smoothed PDM, determining local maximum points of the smoothed CHM and local maximum points of the smoothed PDM, taking the local maximum points of the CHM as tree tops, and taking the local maximum points of the PDM as local maximum density points of point cloud;
taking each of the tree tops as a seed point to perform region growing on the CHM, and assigning each adjacent grid point of the seed point satisfying a set condition to a canopy to which the seed point belongs; and
taking the canopy as an independent area, wherein the canopy has only one maximum height as a tree top of the canopy.

4. The individual-tree segmentation method of UAV LiDAR point cloud based on canopy morphology as claimed in claim 3, wherein the setting condition for assigning the adjacent grid point to the canopy to which the seed point belongs comprises:
1) a height of the adjacent grid point is higher than 60% of a height of the seed point;
2) a height of the adjacent grid point is higher than 60% of an average height of the canopy; and
3) a maximum canopy width of the canopy does not exceed 10 meters.

5. The individual-tree segmentation method of UAV LiDAR point cloud based on canopy morphology as claimed in claim 1, wherein the wrong segmentation canopy comprises an over-segmentation canopy and an under-segmentation canopy; and
wherein the determining each correct segmentation canopy and each wrong segmentation canopy of the canopies according to the number of local density maximum points in each of the canopies, comprises:
in a situation that there is only one local maximum density point in a canopy, determining the canopy as the correct segmentation canopy;
in a situation that there is no local maximum density point in the canopy, determining the canopy as the over-segmentation canopy;
in a situation that there are two or more local maximum density points in the canopy, determining the canopy as the under-segmentation canopy; and
recording a tree top and a local maximum density point of each wrong segmentation canopy.

6. The individual-tree segmentation method of UAV LiDAR point cloud based on canopy morphology as claimed in claim 5, wherein the performing fine segmentation on each wrong segmentation canopy according to canopy morphology to update the set of tree tops and thereby obtain an updated set of tree tops, taking each tree top of the updated set of tree tops as a seed point, and performing region growing on each tree top to thereby obtain a final individual-tree segmentation result, comprises:
projecting all points of each over-segmentation canopy onto an xoy plane to obtain a point set P={p₁, p₂, p₃, . . . , pₙ}, and calculating a covariance matrix cov according to the following formula:
$$cov = \frac{1}{n - 1} ( P - \overline{p} ) {( P - \overline{p} )}^{T} ,$$
where p̅ represents an average value in dimensions of the point set P, n represents the number of the all points of the over-segmentation canopy, and T represents a matrix transposition operation;
performing singular value decomposition on the covariance matrix cov to thereby obtain two eigenvalues λ₁ and λ₂ and two eigenvectors α₁ and α₂, wherein λ₁ corresponds to a major axis of an ellipse and λ₂ corresponds to a minor axis of the ellipse; and in a situation of λ₁/λ₂>3, determining the over-segmentation canopy as an over-segmentation canopy, assigning the over-segmentation canopy to a nearest correct segmentation canopy to the over-segmentation canopy, and removing a tree top corresponding to the over-segmentation canopy from the set of tree tops, otherwise, determining the over-segmentation canopy as a correct segmentation canopy;
taking a tree top of each under-segmentation canopy as a reference point to obtain a vertical plane containing the tree top and a local maximum density point and perpendicular to the xoy plane, and projecting a point cloud within a neighborhood of 0.2 meters of the vertical plane onto the vertical plane to obtain a vertical sectional view;
extracting canopy surface points in the vertical sectional view, and performing polynomial fitting on the canopy surface points to obtain a canopy surface morphology fitting function; determining that the local maximum density point is a top of a under-segmentation tree in a situation that there is a minimum value between the tree top and the local maximum density point of the canopy surface morphology fitting function, and adding the local maximum density point to the set of tree tops for updating the set of tree tops; and determining that the local maximum density point is not a top in a situation that there is no minimum value between the tree top and the local maximum density point of the canopy surface morphology fitting function;
after all wrong segmentation canopies are segmented, obtaining the updated set of tree tops; and
taking each tree top of the updated set of tree tops as a seed point for performing region growing to thereby obtain the final individual-tree segmentation result.

7. The individual-tree segmentation method of UAV LiDAR point cloud based on canopy morphology as claimed in claim 4, wherein the taking each tree top of the updated set of tree tops as a seed point, and performing region growing on each tree top to thereby obtain a final individual-tree segmentation result, comprises:
taking each tree top of the updated set of tree tops as a seed pixel;
comparing the seed pixel with each pixel in a surrounding neighborhood of the seed pixel; and
in a situation of the pixel satisfying the set condition, merging the seed pixel and the pixel to obtain a merged pixel, and taking the merged pixel as a new seed pixel to continue to grow outward until there is no pixel satisfying the set condition.
